(19) United States
(12) Patent Application Publication
(10) Pub. No.: US 2006/0180031 A1
(43) Pub. Date: Aug. 17, 2006

(54) Apparatus for baking, cutting and serving

(76) Inventors: Edward Scott Carlson, Delmont, PA (US); Donald V. Edwards, Harrison City, PA (US)

Correspondence Address: JAMES RAY & ASSOCIATES, 2640 Pitcairn Road, Monroeville, PA, 15146, US

(21) Appl. No.: 11/050,653

(22) Filed: Feb. 3, 2005

Related U.S. Application Data
(60) Provisional application No. 60/541,600, filed on Mar. 29, 2004.

(51) Int. Cl. A47J 17/00

(52) U.S. Cl. 99/352; 99/537

(57) ABSTRACT

An apparatus for at least one of supporting and containing a preselected food product to be at least one of baked, cut and served. The apparatus comprises a base member having a predetermined shape and a predetermined size. There are a plurality of elongated grooves extending from a point closely adjacent an outer edge of the apparatus to a point on an axially opposed outer edge of the apparatus and from an upper surface thereof to a predetermined depth. The plurality of the elongated grooves enabling a cutting means to pass completely through such preselected food product.

### CROSS-REFERENCES TO RELATED APPLICATIONS

The present application is closely related to and claims benefit from U.S. Provisional Application Ser. No. 60/541,600 filed Feb. 3, 2004.

### FIELD OF THE INVENTION

The present invention relates, in general, to a pan or serving tray for heating and serving pizza and other dough based products, and, more particularly, the present invention relates to a pan or serving tray that incorporates vertical slots at designated locations that enable the user to completely cut through the crust every time.

### BACKGROUND OF THE INVENTION

In our present society one of the most commonly consumed food is pizza. Pizza rivals the hamburger and hot dog as being the typical American food. Traditional methods of cooking or baking a pizza and other dough based products consist of either forming dough or placing a preformed crust into a pan, applying the toppings or placing a frozen pizza in a pan and then baking the pizza. The pan is then removed from the oven and either the pizza is cut directly in the pan and the individual pieces removed or the entire pizza is slid out of the pan and then the pizza is cut, typically on a countertop or in a serving tray. When cutting pizza in traditional pans (pans with an exterior vertical side) with a wheel or knife the circular blade never fully cuts the crust because you have a round blade that you push or pull into a square corner. Another common problem that occurs when cutting in pans or on flat surfaces such as pizza stones is that when rolling a circular blade directly into the crust the entire pie tends to want to move in a horizontal plane away from the cutting or even out of the pan altogether.

To avoid this problem many commercial bakeries will frequently cut the pizza directly in the box for shipment. As a result of the existing methods, pizzas are not cut throughout but the pizza is partially connected at the crust. It is necessary to remove the adjacent pieces at the same time and attempt to pull them apart or try to do this with a knife to further cut the crust before the pieces are removed. As a result some topping may fall onto the countertop or back in the box and the user may end up with a piece of pizza without toppings and generally a sticky mess.

### SUMMARY OF THE INVENTION

According to one embodiment of the present invention there is provided an apparatus for at least one of supporting and containing a preselected food product to be at least one of baked, cut and served. The apparatus comprises a base member having a first predetermined shape and a predetermined size. There are a plurality of elongated grooves extending from a point closely adjacent an outer edge of the apparatus to a point on an axially opposed outer edge of the apparatus and from an upper surface thereof to a first predetermined depth. The plurality of elongated grooves enabling a cutting means to pass completely through such preselected food product.

Another embodiment of the invention provides an apparatus for at least one of supporting and containing a preselected food product to be at least one of baked, cut and served. The apparatus comprises a base member having a predetermined shape and a predetermined size and an upstanding wall portion at least one of engageable with, secured to and formed integrally as a single component with the base member. The upstanding wall portion is disposed closely adjacent an outer perimeter of the base member, each of the base member and the upstanding wall portion are formed from a predetermined material, having a predetermined heat resistance which is at least sufficient to withstand temperatures which such preselected food product will reach. There is at least one pair of substantially radially opposed elongated openings extending through the upstanding wall portion from an outer surface of the upstanding wall portion to an inner surface thereof and from an upper surface thereof to a depth at least as deep as an upper surface of the base member, and such that one of the pair of radially opposed elongated openings is disposed closely adjacent a first outer edge portion of the base member and a second one of the pair of the substantially radially opposed elongated openings is disposed closely adjacent a substantially radially opposed second outer edge portion of the base member. The pair of substantially radially opposed elongated openings enabling a cutting means to pass completely through an outermost edge of such preselected food product.

### OBJECTS OF THE INVENTION

It is, therefore, one of the primary objects of the present invention to provide an apparatus which enables the user to cut completely through the crust of a pizza.

It is another object of the present invention to provide an apparatus which enables the user to cut perfectly shaped pizza slices.

Another object of the present invention is to provide an apparatus which can be used with existing equipment, such as pizza wheels, knives and rocker cutters.

It is still another object of the present invention to provide an apparatus which is easy for the user to use.

Still another object of the present invention is to provide an apparatus that is inexpensive to manufacture.

Yet, another object of the present invention is to provide an apparatus which can be used for a variety of baking needs.

Another object of the present invention is to provide an apparatus which will maintain the position of the food product in the pan or tray while being cut.

Still another object of the present invention is to provide an apparatus wherein the food product can either be cut in the heated pan or on a serving tray.

Yet, another object of the present invention is to provide an apparatus that is disposable.

Another object of the present invention is to provide an apparatus in which the food product can be at least one of baked, cut and served.

In addition to the numerous objects and advantages of the present invention which have been described with some degree of particularity above, it should be both noted and understood that a number of other important objects and advantages of the invention will become more readily apparent to those persons who are skilled in the relevant art from the following more detailed description of the invention, particularly, when such detailed description is taken in conjunction with the appended claims.

### BRIEF DESCRIPTION OF THE DRAWINGS

FIG. 1 is a plan view of the apparatus according to an embodiment of the invention.

FIG. 2 is a top view of the apparatus shown in FIG. 1.

FIG. 3 is a cross sectional view of the apparatus shown in FIG. 1.

FIG. 4 is an enlarged view of the circled section labeled A of the apparatus shown in FIG. 3.

FIG. 5 is an enlarged view of the circled section labeled B of FIG. 3.

FIG. 6 is a cross sectional view of the portion of FIG. 3 taken across the lines of VI-VI.

FIG. 7 is a bottom view of the apparatus shown in FIG. 1.

FIG. 8 is a top view of the apparatus according to an alternate embodiment of the invention.

FIG. 9 is a plan view of the apparatus shown in FIG. 1 showing a different embodiment of the invention.

FIG. 10 is an enlarged view of the one of the embodiments of the protrusions seen in FIG. 1.

FIG. 11 is a bottom view of the apparatus shown in FIG. 1 similar to FIG. 7 except that a coating is applied to some of the bottom surfaces to prevent sliding.

FIG. 12 is a plan view of the apparatus according to still another embodiment of the invention.

FIG. 13 is a cross sectional view of the apparatus shown in FIG. 12.

FIG. 14 is an enlarged perspective view of the groove portion of the upstanding wall portion of the apparatus shown in FIG. 12.

FIG. 15 is plan view of the apparatus showing the grooves at the outer edge.

FIG. 16 is a plan view of the apparatus showing closely spaced protuberances in lieu of grooves.

FIG. 17 is an enlarged view of the protuberances shown in FIG. 16.

### BRIEF DESCRIPTION OF THE PRESENTLY PREFERRED AND VARIOUS ALTERNATE EMBODIMENTS OF THE PRESENT INVENTION

Prior to proceeding to the more detailed description of the present invention, it should be noted that for the sake of clarity in understanding the invention, identical components with identical functions have been designated with identical reference numerals throughout the drawing Figures.

Illustrated in the drawing Figures is an apparatus, generally designated 10. Although most of the discussion is devoted toward the use of a round pan, it is within the scope of the invention that such pan could have various shapes. The pan can be round, rectangular, hexagonal or octagonal. It is presently preferred, however, that such pan be round.

The present invention provides an apparatus 10 for containing a preselected food product to be at least one of baked and cut. The apparatus can be used for baking the food product in an oven and insuring that the food product can be cut completely through the crust and also for cutting the food product into perfectly formed slices. Again, the discussion centers primarily on the use of the apparatus for baking and slicing a pizza; however, it is within the scope of the invention that such apparatus 10 can be used for baking bread, pies and other dough based food products and further can be used for serving such products.

The apparatus 10 includes a pan having a predetermined shape and a predetermined size.

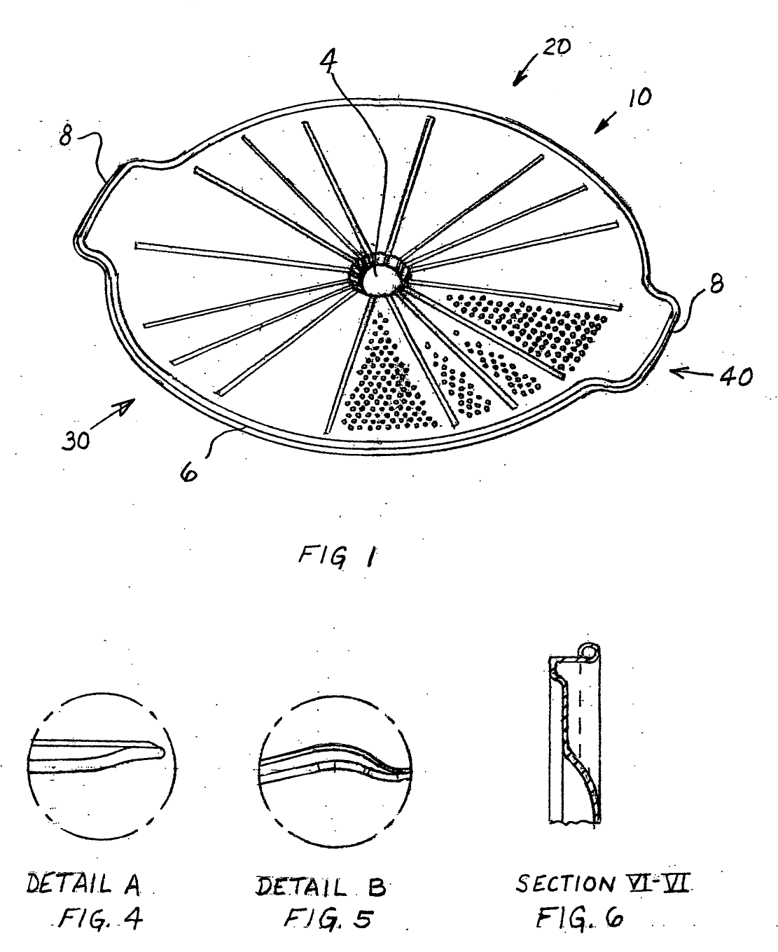

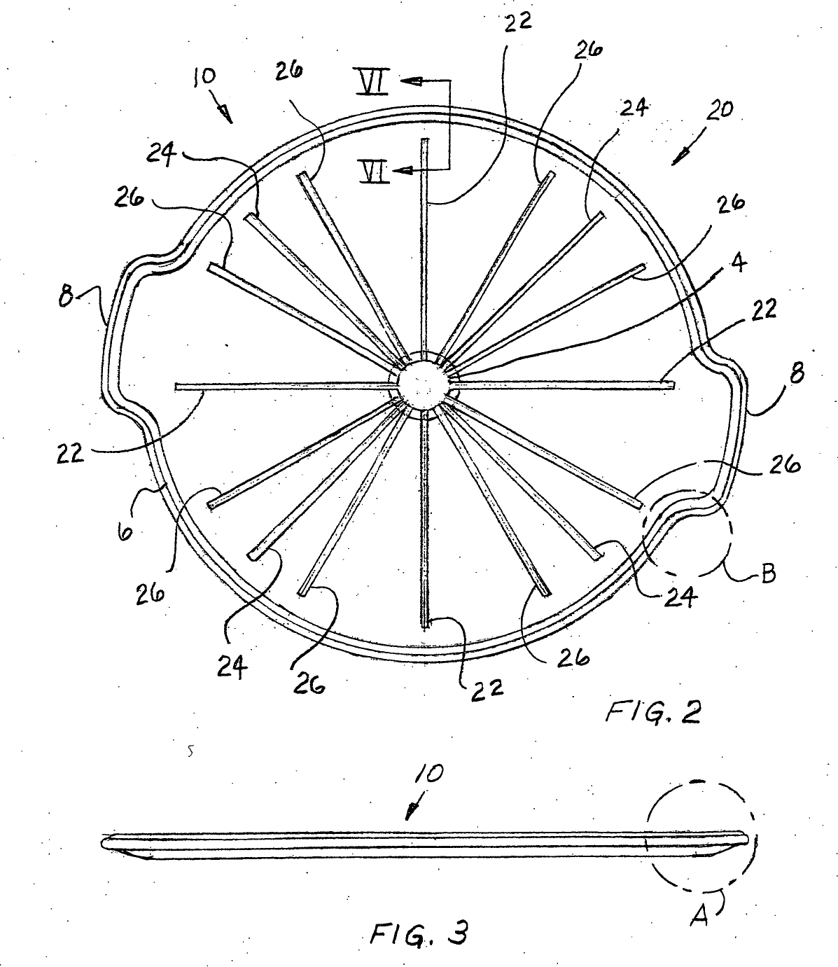

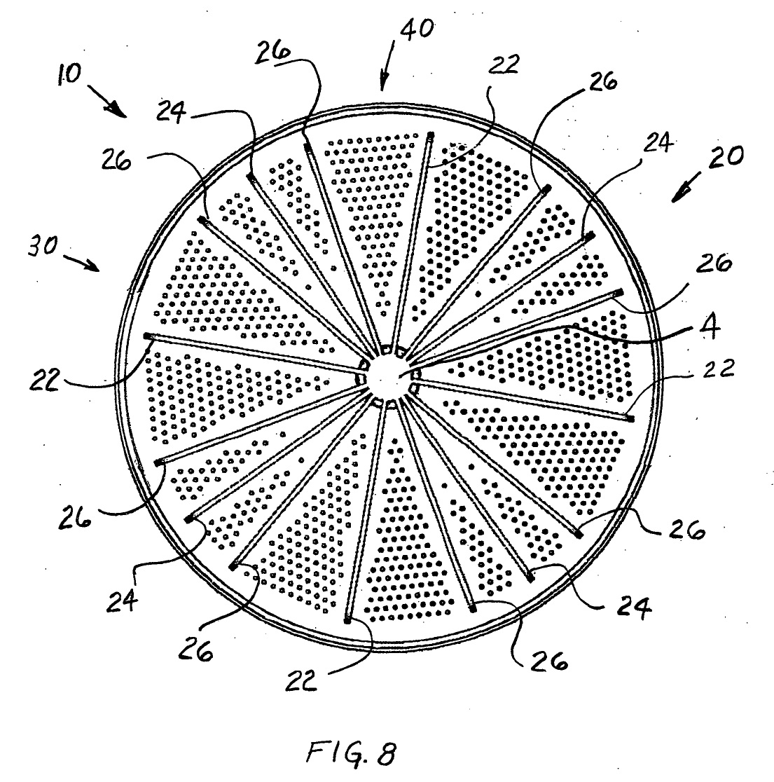

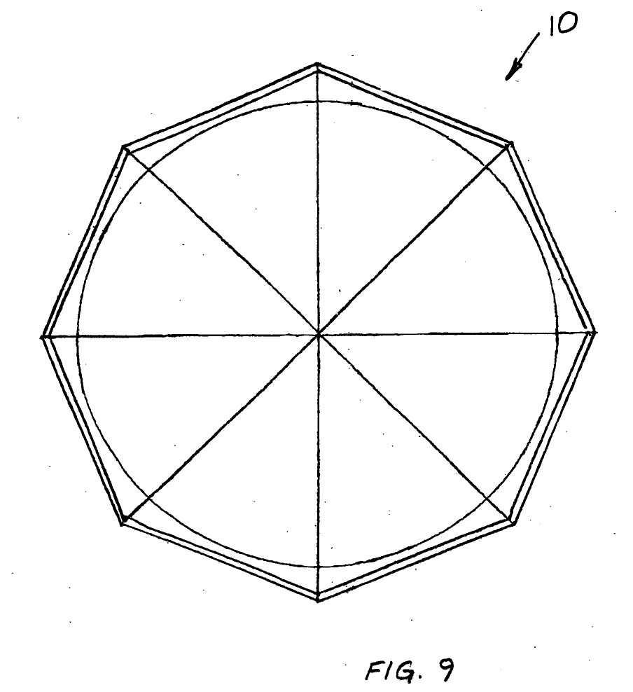

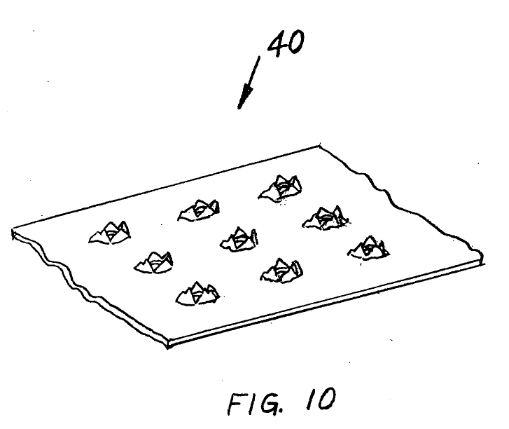

In one embodiment of the invention, as seen in FIGS. 1-10, there is provided an apparatus 10 for at least one of supporting and containing a preselected food product to be at least one of baked, cut and served. The apparatus 10 comprises a base member, generally designated 20, having a first predetermined shape and a predetermined size. There are a plurality of elongated grooves, generally designated 30, extending from a point closely adjacent an outer edge 6 of the apparatus to a point on an axially opposed outer edge 6 of the apparatus and from an upper surface thereof to a first predetermined depth. The plurality of elongated grooves 30 enabling a cutting means to pass completely through such preselected food product.

In a presently preferred embodiment of the invention there is a central cavity 4 formed in the base member 20. The central cavity 4 has a second predetermined shape and a second predetermined depth. In a preferred embodiment of the invention such predetermined shape of such central cavity is generally circular and, further, such central cavity 4 has a larger diameter at the top surface than it does at the bottom of the cavity 4. Thus, the sides of the central cavity 4 are sloped from top of the cavity 4 to the bottom of the central cavity 4. In this embodiment such first and such second predetermined depths are substantially the same. Thus, the plurality of elongated grooves 30 extend from a point closely adjacent an outer edge 6 of the apparatus 10 to the central cavity 4, and from an upper surface thereof to a depth at least as deep as the bottom portion of the central cavity 4. The plurality of elongated grooves 30 enables a cutting means, such as a pizza wheel, to pass completely through such preselected food product and cut such food product into slices.

Generally the invention will be described in relation to its use as a pizza pan and the description will be described as such, however, it is within the concept of the invention that such apparatus 10 could be used for other food products.

Such plurality of grooves 30 can be designed so that such pizza can be cut into a variety of sizes. As seen in the Drawing Figures grooves 22 are used to cut the pizza into 4, 8 or 12 slices. Grooves 24 are used to cut the pizza in 8 equal pieces. Grooves 26 are used to cut the pizza into 12 pieces. Thus the grooves 30 can be used to cut a variety of sizes of slices of pizza since it is also possible to mix and match the grooves 30 so as to permit cutting some pieces in twelfths, others into eights, while still others into fourths.

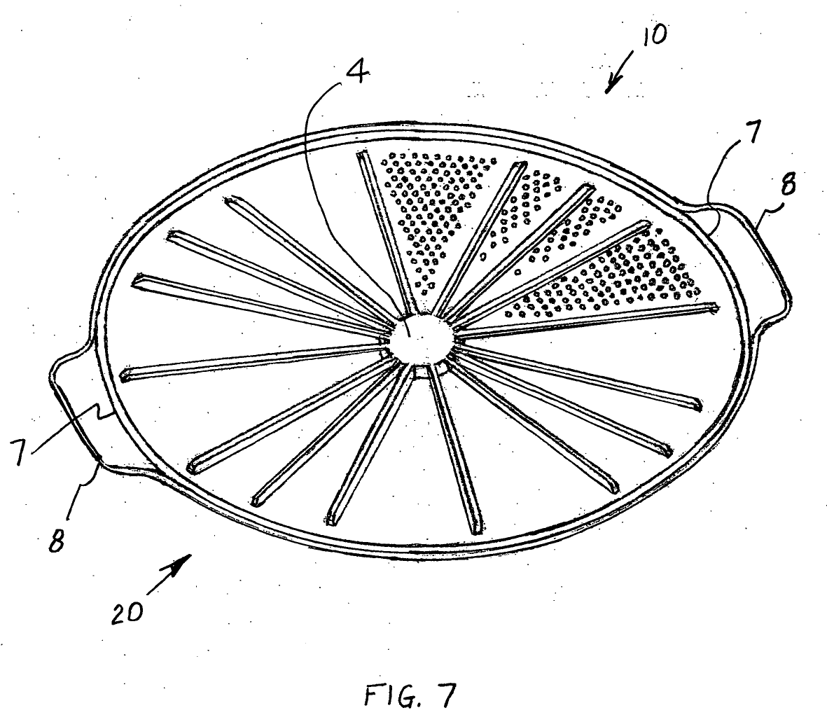

As mentioned previously it should be noted that the bottom of the grooves 30 is substantially on the same plane as the bottom of the central cavity 4 and is also on the same plane as the bottom ring 7, which has a third predetermined depth, and which for the most part is basically a bottom portion of the outer edge 6 or as seen in FIG. 7 is a ring 7 adjacent to such outer edge 6. Such third predetermined depth is at least equal to or greater than such first and such second predetermined depth. It should also be noted that such ring 7 is continuous ring 7 and extends as a continuous portion even in the area where the embodiment which includes a handle portion 8 is elevated over the rest of the base member 20. Thus, when the apparatus is sitting on a flat surface the apparatus is sitting on the bottom of the grooves 20, the bottom of the central cavity 4 and the bottom portion of the ring 7 while the rest of the apparatus is elevated above the surface that such apparatus 10 is sitting on. The ring 7 is important in that sliding such apparatus 10 in a conventional oven the ring 7 presents a continuous bottom surface that would not catch on any arrangement of grills that might be found in such conventional oven.

Such base portion 20 of such apparatus 10 also includes a plurality of protrusions, generally designated 40, formed from a bottom surface through an upper surface of the base member 20.

The protrusions 40 project through the upper surface of such apparatus 10 and engage the pizza being baked. These protrusions 40 serve several functions. First they engage the pizza and prevent it from moving during baking and subsequently during cutting. The protrusions 40 have an opening on the top of the protrusion 40 which act as vent holes allowing moisture to escape through the bottom of the pan and since the pizza sits on top of the protrusions 40 and is raised off of the base portion 20 it creates an air gap (separation) between the pizza and the base portion 20 which allows moisture to escape.

It should also be noted that moisture can also escape from the grooves 30 during baking of such pizza. These grooves 30 also can act as a reservoir to collect excessive grease or fluid from the pizza or toppings during baking which will aid in preventing the crust from absorbing some of the grease and fluid that may be present.

The protrusions 40 have a shape that is at least one of conical, triangular, and half moon. All of these shapes are found on a typical cheese grater. It is presently preferred that such protrusions 40 are conical.

Such predetermined shape of such base portion 20 is generally circular; however, in one embodiment of the invention there are a pair of radially opposed handle portions 8 which extend outwardly from the base portion 20. These handles 8 are slightly raised from the horizontal so that it makes it easy to reach under the handles 8 and move the apparatus 10. It is presently preferred embodiment of the invention that such apparatus 10 have handle members 8 disposed on the base member 20.

It is also an embodiment of the invention that such apparatus further includes a means that is engageable with at least a portion of a bottom surface of the base member for preventing movement of the apparatus on a supporting surface during cutting of the food product. Such means would include a nonskid coating 32 on at least one of such bottom surface of such outer ring 7, such bottom of such central cavity 4 and such grooves 20. Such nonskid means would be selected from a group consisting of natural rubber, synthetic rubber, plastic, silicone and various combinations thereof.

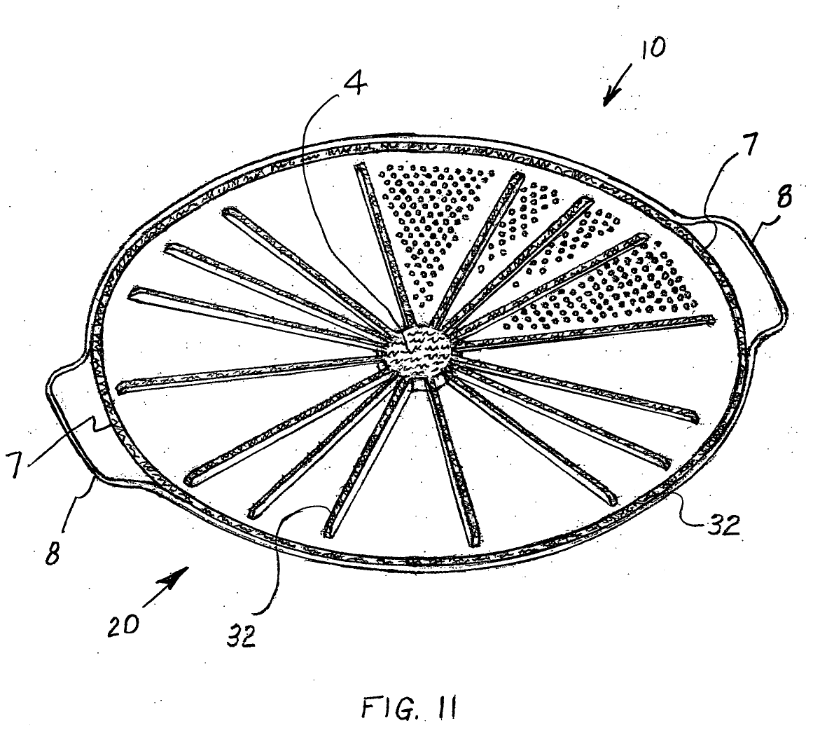

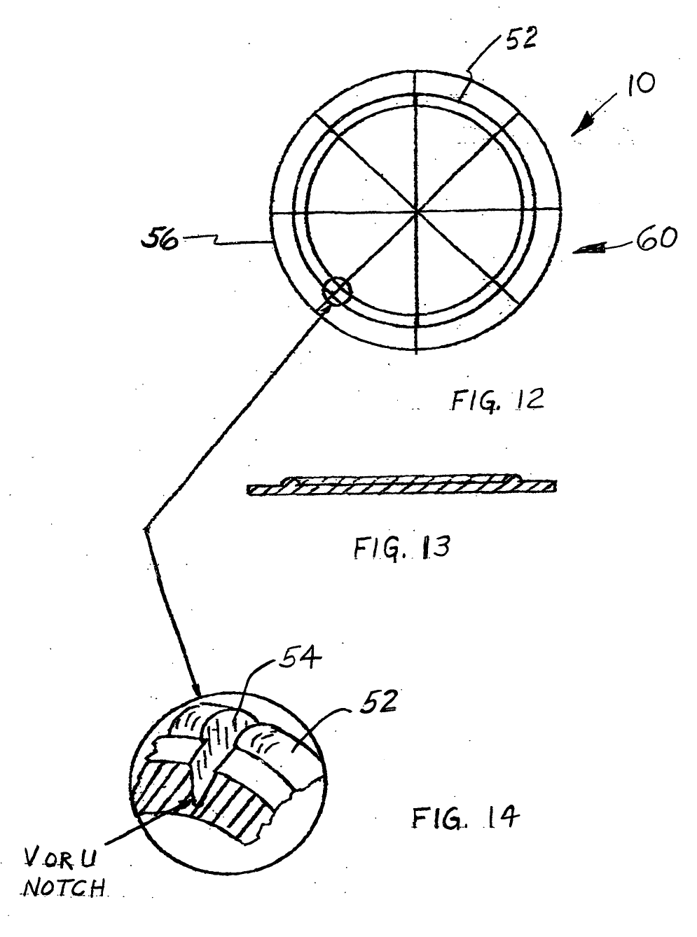

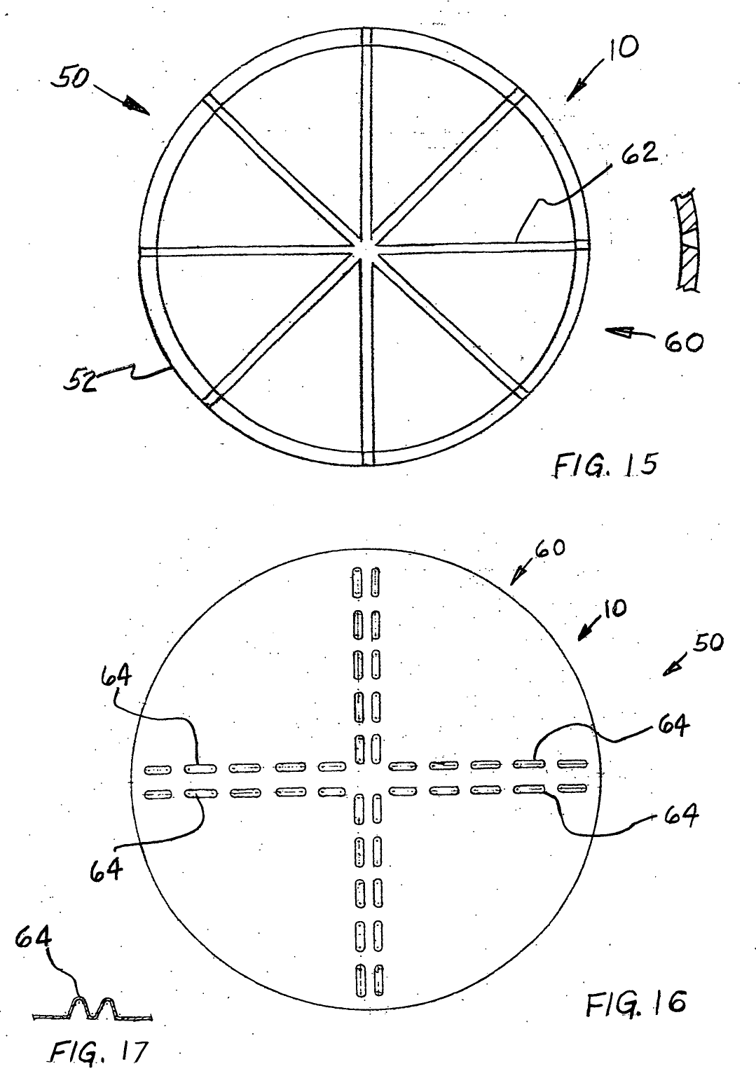

In an other embodiment of the invention, as illustrated in FIGS. 11-16, apparatus 10 has a base member, generally designated 50, which has a predetermined shape and a predetermined size. There is an upstanding wall portion 52 that is at least one of engageable with, secured to and formed integrally with the base member 50. The upstanding wall portion 52 is disposed closely adjacent an outer perimeter of the base member 50. Each of the base member 50 and the upstanding wall portion 52 are formed from a predetermined material. The predetermined material has a predetermined heat resistance which is at least sufficient to withstand temperatures which such preselected food product will reach in the baking of such food product. There is further at least one pair of substantially radially opposed elongated openings 54 extending through the upstanding wall portion 52 from an outer surface of the upstanding wall portion 52 to an inner surface thereof and from an upper surface thereof to a depth at least as deep as an upper surface of base member 50, and such that one of the pair of radially opposed elongated openings 54 is disposed closely adjacent a first outer edge portion 56 of the base member 50 and a second one of the pair of substantially radially opposed elongated openings 54 is disposed closely adjacent a substantially radially opposed second outer edge portion 56 of the base portion. The pair of substantially radially opposed elongated openings 54 enabling a cutting means to pass completely through an outermost edge of such preselected food product.

According to an embodiment of the invention there is at least one elongated guide means, generally designated 60, that is disposed at least one of in and on the base portion for guiding such cutting means through such preselected food product. According to one embodiment the elongated guide means 60 includes a predetermined plurality of grooves 62 formed in the base member 50. Thus, cutting the pizza can be accomplished by cutting in the grooves 62 to ensure that a perfect cut through the crust is made. It should be noted that the grooves may have a variety of shapes such a V or a U or other similar configurations.

These grooves 62 in the base member 50 correspond to the pair of substantially radially opposed elongated openings 54 extending through the upstanding wall portion 52 whereby the cutting begins in elongated opening 54 in wall portion 52 and continues through the pizza along the grooves 62 in the base member 50. Having the elongated opening 54 extend down to the base member 50 insures that the outer crust of the pizza will be cut completely through and thereby eliminating one of the problems with cutting of most pizzas in that they are usually still connected at the crust and the pieces have to be pulled apart.

The pair of elongated openings 54 are radially opposed and thus will be disposed at each end of the grooves 62 that are in the base member 50. There will be twice as many elongated openings 54 as there are grooves 62 in the base member 50.

The grooves 62 in the base member 50 extends substantially the width of the base member 50 and basically form diametric grooves in a round pan or lengthwise and widthwise parallel grooves in a rectangular pan.

In another embodiment of the invention instead of grooves in the base member 50 the elongated guide means 60 includes pairs of closely spaced, substantially parallel protuberances 64 formed in the base member 50. These pairs of closely spaced, substantially parallel protuberances 64 form a linear channel therebetween. These channels will be comparable to the grooves 62.

Thus, regardless of whether the embodiment is grooves on the base of the pan or protuberances forming a channel on the base of the pan when the pizza is being cut the blade begins in one of the pair of elongated openings in the upstanding wall portion. In some embodiments the pizza wheel continues through the pizza in the groove or channel in the base portion. The pizza wheel will always cut through the crust since the blade will cut through to the base of the pan and then through the channel or groove which is always lower than the bottom of the pizza. Also the outer crust of the pizza will be cut through since the cut is begun before the blade touches the outer portion of the pizza.

There are a wide variety of shapes that can be used for the grooves as is evident in the drawing Figures. The grooves may be rectangular, rectangular with a V-like top portion, U-shaped or V-shaped. It is presently preferred that such grooves be V-shaped or U-shaped. It is also presently preferred that the grooves in the base portion and the elongated openings in the upstanding wall portion have the same shape. It is also preferred that the elongated openings in the upstanding wall portion have a smooth surface.

The pan or tray can be constructed of a variety of materials. The pan or tray can be made of metal, plastic, ceramic, fluorocarbon, clay, paper, stone, silicone, glass or combinations thereof. It is also an embodiment of the invention that the pan have a fluorocarbon (Teflon) coating on the inside of the pan for easy removal of the pizza or other food product.

Again using pizza as the food product being cut, it is important to start the cutting with the pizza roller outside the base in the upstanding wall portion and continue through the grooves on the pan to insure that the crust is cut all the way through.

The pan further includes an edge portion that extends between the upstanding wall portion and the outer perimeter of the pan. This portion is important to help prevent sauce or other food product from possibly spilling over the upstanding wall portion and getting in the oven or on the counter.

It is within the scope of the invention that the base portion of such pan be perforated to enhance even baking by allowing moisture to escape thus providing a crispy crust. Along with the perforations there are also a plurality of protuberances on the underside of the base portion to raise the base portion so as to permit better air circulation with the perforated pan.

The apparatus can also be provided with a means that is at least one of engageable with and formed on the inner surface of upstanding wall portion or/and the upper surface of the base portion for preventing such food product from sliding on the base portion. In one embodiment of the invention there are provided raised portions or projections on the base portion of the pan to help prevent the food product being cut from sliding on the pan, while in another embodiment there are inward projections on the upstanding wall portion that prevent the pizza from moving when it is being cut.

In still another embodiment of the invention there is provided some resilient material in the base of the grooves in both the first and second plurality of grooves. This is designed to prevent the pizza roller or other cutting means from wearing out the pan prematurely and thus extends the life of the pizza cutter and the pan. It is presently preferred that such resilient material be selected from a group including silicone, natural rubber, synthetic rubber and plastic.

In still another embodiment of the invention the pan is provided with non-skid, non-scratch pads on the bottom of base in order to protect countertops or tables when such hot pans are placed thereon.

As stated previously it is presently preferred that such pan be round. In this embodiment the grooves in the base portion are diametric. They form a diameter across the surface of the pan. The plurality of grooves can be any number, but it could possibly be two for a personal size pizza or four diametric grooves in the pan which will provide eight perfectly formed slices of the food product. However, there may be more grooves than four in the pan. There may be six or eight (or even an odd number) diametric grooves which would provide 12 and 16 slices, respectively. It is also an embodiment of the invention that such grooves are not necessarily uniform, but may be spaced such there can be different sizes of slices of pizzas that are cut. This embodiment is clearly visible in FIG. 1. In the embodiment of the invention with wall portions, regardless of the number of diametric grooves or the size of the slices of pizza there will always be corresponding elongated openings in the upstanding wall portion to match the grooves in the pan. The above discussion is devoted to a plurality of grooves; however, as stated previously a plurality of protuberances forming a channel may be used instead of the grooves and also as stated previously there may be neither grooves nor protuberances in the pan base.

The pan may also include an edge portion that extends between the upstanding wall portion and the outer perimeter of the pan. This portion is important to help prevent sauce or other food product from possibly spilling over the upstanding wall portion and getting in the oven or on the counter.

As evident in the other embodiment it is within the scope of the invention that the base portion of such pan have a plurality of protrusions with openings at the top of the protrusions to enhance even baking by allowing moisture to escape thus providing a crispy crust and for preventing such food product from sliding.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for at least one of supporting and containing a preselected food product to be at least one of baked, cut and served, said apparatus comprising:
(a) a base member having a first predetermined shape and a predetermined size;
(b) a plurality of elongated grooves extending from a point closely adjacent an outer edge of said apparatus to a point on an axially opposed outer edge of said apparatus and from an upper surface thereof to a first predetermined depth, said plurality of said elongated grooves enabling a cutting means to pass completely through such preselected food product.

2. An apparatus, according to claim 1, wherein said apparatus further includes a central cavity formed in said base member, said central cavity having each of a second predetermined shape and a second predetermined depth.

3. An apparatus, according to claim 2, wherein said central cavity intersects each of said plurality of elongated grooves substantially at a center thereof.

4. An apparatus, according to claim 2, wherein said first predetermined depth and said second predetermined depth are substantially equal.

5. An apparatus, according to claim 1, wherein said base member further includes a plurality of protrusions extending upwardly from an upper surface of said base member.

6. An apparatus, according to claim 5, wherein each of said plurality of protrusions have an opening adjacent an upper portion thereof, said protrusions enhancing heat transfer to a bottom surface of such food product being baked and for preventing movement of such food product during cutting.

7. An apparatus, according to claim 5, wherein said protrusions have a shape of at least one of conical, triangular, rectangular and half moon.

8. An apparatus, according to claim 7, wherein said protrusions are conical.

9. An apparatus, according to claim 1, wherein said at least one of said first and said second predetermined shape is substantially circular.

10. An apparatus, according to claim 1, wherein said base member includes a pair of radially opposed handle portions which extend outwardly from said base member.

11. An apparatus, according to claim 10, wherein an outer end of said handle portions is elevated from a horizontal plane of said base member.

12. An apparatus, according to claim 1, wherein said plurality of said elongated grooves are formed so such food product can be cut into at least one of fourths, eights and twelfths.

13. An apparatus, according to claim 2, wherein said base member further includes a ring member, said ring member extending downwardly from said base member to a third predetermined depth, said third predetermined depth being one of substantially equal to and greater than said first and said second predetermined depth.

14. An apparatus, according to claim 1, wherein said apparatus further includes a means engageable with at least a portion of a bottom surface of said base member for preventing movement of said apparatus on a supporting surface during cutting of said food product.

15. An apparatus for at least one of supporting and containing a preselected food product to be at least one of baked, cut and served, said apparatus comprising:
(a) a base member having a predetermined shape and a predetermined size;
(b) an upstanding wall portion at least one of engageable with, secured to and formed integrally as a single component with said base member, said upstanding wall portion disposed closely adjacent an outer perimeter of said base member, each of said base member and said upstanding wall portion formed from a predetermined material, said predetermined material having a predetermined heat resistance which is at least sufficient to withstand temperatures which such preselected food product will reach; and
(c) at least one pair of substantially radially opposed elongated openings extending through said upstanding wall portion from an outer surface of said upstanding wall portion to an inner surface thereof and from an upper surface thereof to a depth at least as deep as an upper surface of said base portion, and such that one of said pair of radially opposed elongated openings is disposed closely adjacent a first outer edge portion of said base portion and a second one of said pair of said substantially radially opposed elongated openings is disposed closely adjacent a substantially radially opposed second outer edge portion of said base member, said pair of substantially radially opposed elongated openings enabling a cutting means to pass completely through an outermost edge of such preselected food product.

16. The apparatus, according to claim 15, wherein said apparatus further includes at least one elongated guide means disposed at least one of in and on said base member for guiding such cutting means through such preselected food product.

17. The apparatus, according to claim 16, wherein said elongated guide means includes a predetermined plurality of grooves formed in said base member.

18. The apparatus, according to claim 17, wherein said grooves formed in said base portion have one of a U-shape and a V-shape.

19. The apparatus, according to claim 15, wherein outer edges of said at least one pair of substantially radially opposed elongated openings are rolled so as to provide a smooth surface.

20. The apparatus, according to claim 16, wherein said elongated guide means include pairs of closely spaced, substantially parallel protuberances formed on said base portion forming a linear channel therebetween.

21. The apparatus, according to claim 15, wherein said predetermined shape of said base portion is one of round, rectangular, hexagonal and octagonal.

22. The apparatus, according to claim 21, wherein said predetermined shape is round.

23. The apparatus, according to claim 15, wherein said base member further includes an edge portion extending between said upstanding wall portion and said outer perimeter of said base portion.

24. The apparatus, according to claim 15, wherein said apparatus further includes a means at least one of engageable with and formed on at least one of said inner surface of said upstanding wall portion and said upper surface of said base portion for preventing such food product from sliding on said base portion.

25. The apparatus, according to claim 24, wherein said means further includes a plurality of raised protrusions on said base member.
